(19) United States
(12) Patent Application Publication
(10) Pub. No.: US 2003/0084586 A1
(43) Pub. Date: May 8, 2003

(54) Massage diffuser

(76) Inventor: Hou On Lo, Kowloon (CN)

Correspondence Address: ALIX YALE & RISTAS LLP, 750 MAIN STREET, SUITE 1400, HARTFORD, CT, 06103, US

(21) Appl. No.: 10/023,242

(22) Filed: Dec. 20, 2001

(30) Foreign Application Priority Data
Nov. 5, 2001 (CN) 01136142.5

(51) Int. Cl. B05B 1/14

(52) U.S. Cl. 34/96; 239/548

(57) ABSTRACT

An air diffuser produces a massage effect by concentrating air flow through openings in a rotating valve disc. The valve disc includes vanes which, when acted on by air flow through the diffuser, impart a rotational movement to the valve disc. Air passing through the valve disc openings is further concentrated by tapered air outflow nozzles before being directed onto the head of a user. The rotating pattern of air pressure massages the user's head.

### BACKGROUND OF THE INVENTION

1. Field of the Invention

The present invention relates to an air diffuser for attachment to an air blowing appliance and, more specifically, to an air diffuser having a massage effect for attachment to a hair dryer.

2. Description of the Related Art

Hair dryers for use in the home and salon are well known. Hair dryers come in a variety of shapes and sizes and may include a variety of air diffusers for shaping or diffusing the air discharge from the dryer. Some air diffusers are in the shape of an inverted bowl that is placed over the head for drying the hair of a seated user. The primary purpose of prior art air diffusers is to spread or shape the air output of a hair dryer into a configuration suitable for a particular purpose. Prior art air diffusers tend to produce a single stable air flow configuration.

### SUMMARY OF THE INVENTION

An object of the present invention is to provide a new and improved air diffuser which produces a rotating air flow pattern.

Another object of the present invention is to provide a new and improved air diffuser in which the air flow pattern produced has a massage effect on the head of the user.

These and other objects of the present invention are achieved in an air diffuser that includes an air-driven rotating baffle that opens and closes output ports in a rotating pattern. One embodiment of the massage diffuser includes a rear housing portion equipped with an air input receptacle for receiving the output of an air blowing device such as a hair dryer. The hair dryer or other air blowing device may also provide heated air output as is known in the art. The rear housing portion is configured in the form of a bowl that flares radially outwardly from the input receptacle to an outer rim. A front housing portion is configured to mate with the rear housing portion along the rim to define a generally hemispherical interior space. The front housing section defines a plurality of air output nozzles.

A valve disc is mounted for rotation within the space defined by the assembled air diffuser housing. Air flow through the housing acts on vanes fixed to the valve disc to impart rotational movement to the valve disc. The periphery of the valve disc is configured to block air flow through the air output nozzles. A symmetrical pattern of valve openings in the valve disc permit air to pass through the valve disc to emerge from the air output nozzles in a rotating pattern. The air output nozzles may be configured in a funnel shape with the tip of each nozzle being smaller than the root. Such a configuration increases the velocity of air passing through the output nozzle and increases the resulting pressure on the scalp of a person using the air diffuser. This pressure produces a massage effect. Radially inwardly of the primary air output nozzles, the front housing portion includes exhaust openings to ensure sufficient air flow through the valve disc vanes to produce the desired valve disc rotation. The front housing section may include a plurality of smaller air output openings that permit excess air volume to flow toward the user for drying purposes.

A massage effect is produced by the rotating pattern of air directed through the output nozzles toward the user. The use of heated air output from the air pump or source further increases the massage effect.

### BRIEF DESCRIPTION OF THE DRAWINGS

FIG. 1 is a bottom perspective view of a massage diffuser in accordance with the present invention;

FIG. 2 is a sectional view through the massage diffuser of FIG. 1;

FIG. 3 is an exploded bottom perspective view of an alternative embodiment of a massage diffuser in accordance with the present invention; and

FIG. 4 is an exploded overhead perspective view of the massage diffuser of FIG. 3.

### DETAILED DESCRIPTION OF THE PREFERRED EMBODIMENT

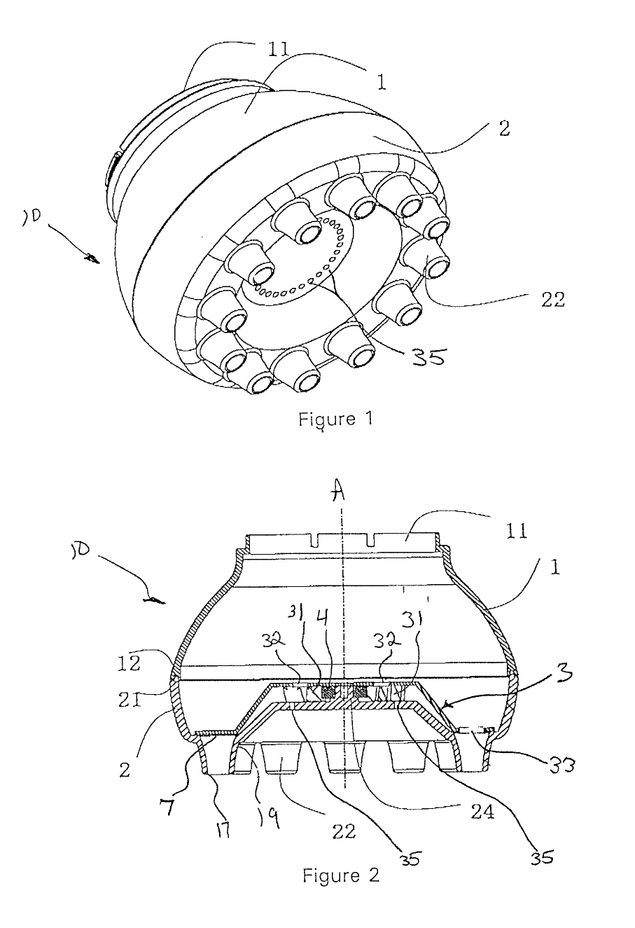

With reference to the drawings, wherein like numerals represent like parts throughout the several figures, a massage diffuser in accordance with the present invention is generally designated by the numeral 10. With reference to FIGS. 1 and 2, a first embodiment of a massage diffuser 10 in accordance with the present invention comprises a rear housing portion 1, a front housing portion 2 and a rotating valve disc 3. The rear housing portion 1 defines a receptacle 11 for attaching the massage diffuser 10 to the output of a hair dryer or other air blowing appliance (not illustrated). The rear housing portion 1 flares from the receptacle 11 to a forward lip 12 configured to mate with the rear lip 21 of the front housing portion 2. Together, the rear shell 1 and front shell 2 define a generally hemispherical interior space with a central axis A.

The illustrated front shell 2 defines twelve air output nozzles 22. Each air output nozzle narrows from a root end 19 directed toward the interior of the air diffuser to a tip 17 directed away from the front housing portion. This output nozzle configuration serves to accelerate the velocity of air passing through each nozzle 22. The circular valve disc 3 is rotatably mounted to the inside of the front housing section 2. A mounting post 24 projects from the front housing section 2 to support a bearing 4 on which the valve disc 3 is supported for rotation. That side of the valve disc 3 facing the air input receptacle 11 is provided with a plurality of openings 32. Air passing through these openings 32 acts on angled vanes 31 to impart a rotational force on the valve disc 3. Front housing portion 2 further defines a plurality of exhaust openings 35 axially aligned with the aforementioned valve disc openings 32. This arrangement of valve disc openings 32, angled vanes 31 and exhaust openings 35 permit a flow of air through the valve disc 3 and front housing portion 2 to produce the desired rotation of the valve disc 3.

The perimeter of the valve disc 3 is a radially extending lip 7 configured to cover the output nozzles 22. In the illustrated embodiment, the perimeter lip 7 is provided with through openings 33. Rotation of the valve disc 3 causes the opening 33 to pass over a particular output nozzle 22, permitting air to flow through the output nozzle 22. Air flow through the air diffuser 10 rotates the valve disc 3 to open and close the output nozzles 22 in a rotating pattern. It should be noted that air flow that is not used to rotate the valve disc 3 accumulates inside the air diffuser 10 until the valve disc opens one or more output nozzles 22. The accumulated air is further accelerated by the tapered output nozzles 22. The concentration of air flow through the air diffuser 10 into a rotating discharge produces a massage effect on the scalp of a person using an appliance equipped with the air diffuser.

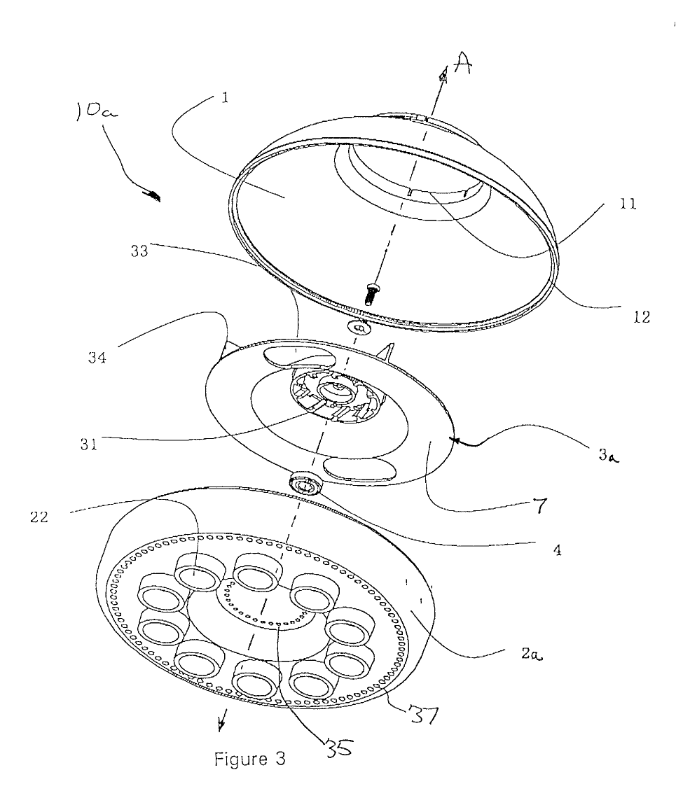

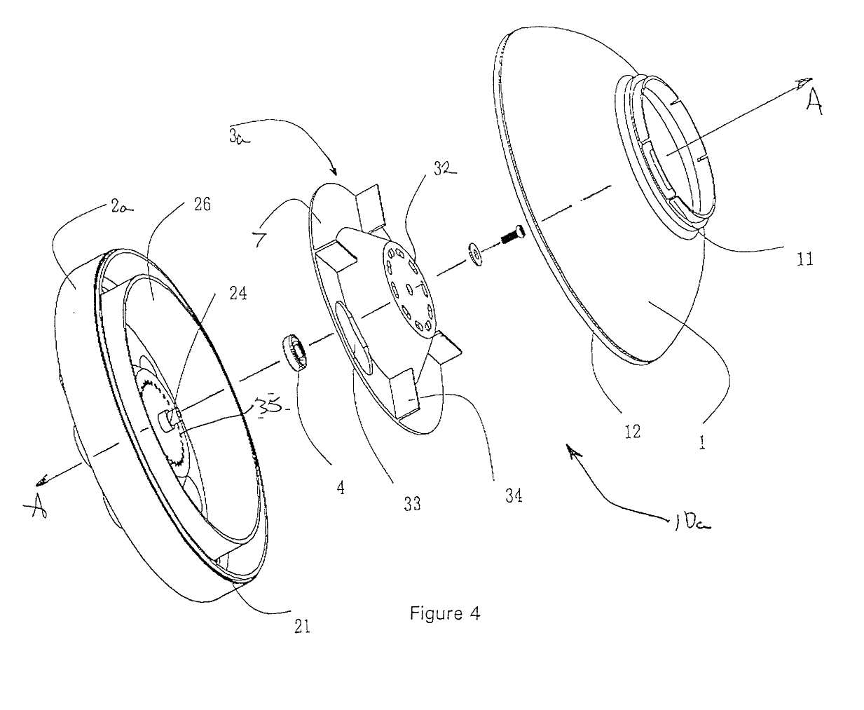

FIGS. 3 and 4 are exploded diagrams illustrating an alternative preferred embodiment of an air diffuser 10a in accordance with the present invention. The housing portions 1, 2a and valve disc 3 operate in essentially the same manner as the previously described embodiment 10. The air diffuser 10a is again symmetrically arranged about a central axis A. FIG. 3 provides an excellent view of the angled vanes 31 and their position between valve disc openings 32 and exhaust openings 35. The valve disc 3a is supported by a bearing 4 for rotation about mounting post 24.

The alternative preferred embodiment 10a includes an additional row of small air output openings 37 arranged around the radially outward perimeter of front housing portion 2a. The front shell portion 2a also includes a rearwardly projecting wall 26 which surrounds the rotatably mounted valve disc 3a. The wall 26 serves to concentrate air flow toward valve disc openings 33. The valve disc 3a associated with the alternative preferred embodiment 10a also includes rearward projecting equiangularly spaced vanes 34 to further direct air flow on the openings 33 to improve air pressure at the open output nozzles 22.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

What is claimed is:

1. An air diffuser comprising:
a housing defining an interior space extending from an air inflow opening to a plurality of equiangularly spaced primary air outflow openings radially spaced from a central axis of said housing; and
a valve disc mounted for rotation within said housing, said valve disc comprising an air flow blocking plate centered on an axis of rotation, said plate positioned to block air flow through a majority of said plurality of primary air outflow openings and defining at least one valve opening to permit air flow through said plate, said at least one valve opening spaced a radial distance from said housing central axis such that said valve opening is in axial alignment with said primary air outflow openings, said plate further comprising means responsive to air flow through said housing for producing rotation of said valve disc,
wherein air flow induced rotation of said valve disc produces a rotating pattern of air flow through said plurality of air outflow openings.

2. The air diffuser of claim 1, wherein said housing comprises a coupler surrounding said air inflow opening for coupling said air diffuser to a source of pressurized air flow.

3. The air diffuser of claim 1, wherein said housing comprises:
a generally bowl-shaped rear housing portion which increases in diameter from said air inflow opening to an axially separated first connecting lip; and
a front housing portion comprising a second connecting lip complementary to said first connecting lip, said front housing portion defining said plurality of air outflow openings.

4. The air diffuser of claim 1, wherein said housing defines at least one secondary air outflow opening; and
said means responsive to air flow comprising a plurality of vanes fixed to said valve disc and at least one vane opening through said valve disc, said plurality of vanes having an angled orientation relative to said axis of rotation,
wherein said at least one secondary air outflow opening and said at least one vane opening are substantially equally radially spaced from said axis of rotation and air flow through said at least one vane opening and said at least one secondary air outflow opening acts on said plurality of vanes to produce rotation of said valve disc.

5. The air diffuser of claim 1, wherein said at least one valve opening comprises a plurality of valve openings symmetrically distributed on said plate.

6. The air diffuser of claim 1, wherein said housing comprises a shaft aligned with said housing central axis and projecting into said interior space and said valve disc is rotatably mounted to said shaft.

7. The air diffuser of claim 1, wherein said valve disc is supported for rotation by a bearing.

8. The air diffuser of claim 1, wherein said primary air outflow openings extend axially from a root connected to said housing to a tip projecting away from said housing, each said primary air outflow opening having a first cross sectional area at said root and a second cross sectional area at said tip, said second cross sectional area being smaller than said first cross sectional area.

9. The air diffuser of claim 1, wherein said housing comprises a wall projecting into said interior space toward said air inflow opening, said wall surrounding said primary air outflow openings and a periphery of said valve disc and spaced from the radial limit of said housing.

10. The air diffuser of claim 9, wherein said housing defines a plurality of tertiary air outflow openings arranged between said wall and said radial limit of said housing.
